(19) United States
(12) Patent Application Publication
(10) Pub. No.: US 2003/0086685 A1
(43) Pub. Date: May 8, 2003

(54) Portable digital photograph viewer

(76) Inventors: George R. Bowden III, Portland, OR (US); Edwin L. Jacks JR., Aloha, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/324,692

(22) Filed: Dec. 19, 2002

Related U.S. Application Data
(62) Division of application No. 09/004,052, filed on Jan. 7, 1998.

(51) Int. Cl. H04N 5/76; H04N 5/225

(52) U.S. Cl. 386/46; 386/117

(57) ABSTRACT

A device having a portable digital photograph viewer and a base unit for accepting various personal accessories is disclosed. According to one embodiment, the device includes non-volatile memory to store a number of digital photographs, a display to render the stored digital photographs, a processor to control the rendering of the stored digital photographs, and an enclosure to house these components. The enclosure's physical dimensions are in the order of portable hand held devices, and the display is sized in a complementary manner and disposed on a surface of the enclosure.

### RELATED APPLICATION

This application is a divisional of application Ser. No. 09/004,052 filed Jan. 7, 1998.

### BACKGROUND OF THE INVENTION

1. Field of the Invention

The present invention relates to the field of digital photography. More specifically, the present invention relates to viewing apparatus for digital photographs.

2. Background Information

As advances in microprocessor and other related technologies continue to improve the price/performance of various electronic components, digital photography has become increasingly popular in recent years. Numerous digital cameras are now available in the market place. Examples of digital cameras include the DC 20, manufactured by Kodak of Syracuse, N.Y., and QV 10, manufactured by Casio Computer Co., Ltd., Japan.

Notwithstanding their superior versatility over conventional film based photographs, most users of digital cameras continue to share their digital photographs with their relatives and friends in the conventional manner, that is through prints of the photographs. Some users share their digital photographs through diskettes and other removable storage medium, however this approach requires the viewer to have access to a computer equipped with compatible software. An example of such compatibility would be the ability of the software to handle the same picture format for all the pictures. Other more sophisticated users exploit the Internet, and upload their digital photographs to a private website for access by families and friends. However, this approach will remain too complicated and too costly for many users in the foreseeable future.

### BRIEF DESCRIPTION OF DRAWINGS

The present invention will be described by way of exemplary embodiments, but not limitations, illustrated in the accompanying drawings in which like references denote similar elements, and in which:

FIGS. 1a-1b are block diagrams illustrating perspective and internal architectural views of the portable digital photograph viewer, according to one embodiment;

FIG. 2 is a flow diagram illustrating the operational flow of the control logic provided to the processor of FIG. 1b, according to one embodiment;

FIGS. 3 is a block diagram illustrating a portable digital photograph viewer assembly having a base unit, according to one embodiment; and

FIGS. 4-6 are block diagrams illustrating various portable digital photograph viewer and personal accessory combinations, including a viewer and organizer combination, a viewer and wallet combination, and a viewer and key chain combination, according to one embodiment.

### DETAILED DESCRIPTION

In the following description, various aspects of the embodiments of the present invention will be described. Those skilled in the art will also appreciate that the embodiments may be practiced with only some or all aspects. For purposes of explanation, specific numbers, materials and configurations are set forth in order to provide a thorough understanding of the embodiments of the present invention. However, it will also be apparent to one skilled in the art that the embodiments of the present invention may be practiced without the specific details. In other instances, well-known features are omitted or simplified.

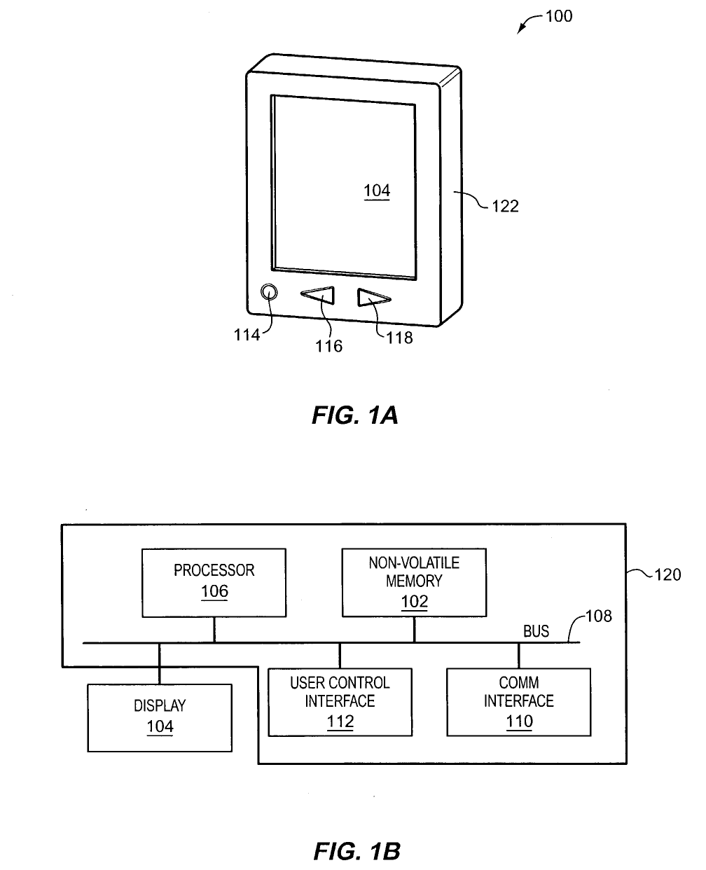

Referring now to FIGS. 1a-1b, wherein a perspective view and an internal architectural view of one embodiment of the portable digital photograph viewer (portable viewer) are shown. As illustrated, portable viewer 100 includes non-volatile memory 102 that operates to store a number of digital photographs, flat panel display 104 that operates to render the stored digital photographs, and processor 106 that operates to control said rendering of the stored digital photographs on flat panel display 104. As illustrated, non-volatile memory 102, flat panel display 104, and processor 106 are coupled with each other by way of bus 108.

For the illustrated embodiment, portable viewer 100 also includes a communication interface 110 for facilitating receive of the digital photographs from an external source, and user control interface 112 for receiving viewing control inputs from a user. External source may be a digital camera, a palm computer, a laptop computer, a deskside computer, a desktop computer or other like equipment. For the illustrated embodiment, portable viewer 100 includes power button 114, forward button 116 and backward button 118. Power button 114 is used to power on and power off portable viewer 100. Forward button 116 is used to control viewing of a next digital photograph in a forward direction, whereas backward button 118 is used to control viewing of a next digital photograph in a backward direction. The forward and backward control inputs are provided to processor 106 through user control interface 112. Of course, additional controls may be provided.

Various components, i.e., non-volatile memory 102, processor 106, bus 108, communication interface 110 and user control interface 112 are disposed on printed circuit board 120. Printed circuit board 120 and the above-enumerated components 102 and 106-112 are housed by an enclosure 122. As illustrated, flat panel display 104 and control buttons 114-118 are disposed on the front surface of enclosure 122, and are coupled with bus 108. In accordance with one embodiment, the physical dimensions of portable viewer 100 are on the order of handheld portable devices. Further, flat-panel display 104 is sized accordingly, i.e., smaller than the physical dimensions of enclosure 122, to allow flat panel display 104 to be disposed on the front surface of enclosure 122. In one embodiment, enclosure 122, and therefore, portable viewer 100, may have a physical dimension of 4″ high ×5″ wide×0.75″ thick. In other words, whether it is packaged in the illustrated standalone embodiment, or integrated with other common portable personal accessories, selective examples of which will be described in more detail below, portable viewer 100 is highly portable.

Non-volatile memory 102 is intended to represent a broad category of such memory known in the art, including and not limited to block erasable flash memory, electrically erasable programmable read-only-memory (EEPROM), and complementary metal oxide semiconductor (CMOS) memory. The amount of memory required is application dependent, i.e., it is dependent on the number of digital photographs supported and the photograph format supported. Except for high-end models, it is expected that a small amount of today's inexpensive non-volatile memory will suffice. Flat panel display 104 is also intended to represent a broad category of such display known in the art, including and not limited to 4.3″ HR-TFT Super Mobile LCD manufactured by Sharp Electronics of Osaka, Japan. As described earlier, flash panel display 104 is expected to be a relatively small display, thereby maintaining portable viewer's 100 portability and keeping its manufacturing cost low.

Processor 106 is intended to represent 8-bit or more microcontrollers (MCU), 16-bit or more digital signal processors (DSP), as well as 32-bit or more general-purpose microprocessors (MP). Except for high-end models with very high capacity and additional controls, it is expected that inexpensive 8-bit MCU will suffice. Similarly, bus 108, communication interface 110, and user control interface 112 are intended to represent a number of these inexpensive components known in the art. Accordingly, portable viewer 100 may be manufactured inexpensively. Thus, coupled with the its high portability, portable viewer 100 loaded with a user's digital photographs may be readily gifted to relatives and friends, resulting in relatives and friends being able to view the user's digital photographs, without requiring the relatives and friends to have compatible equipment, nor the user having the trouble to put his/her digital photographs on a website. Additionally, the portable and inexpensive nature of portable viewer 100 may also allow for it to be integrated into a number of personal accessories as will be described in more detail below.

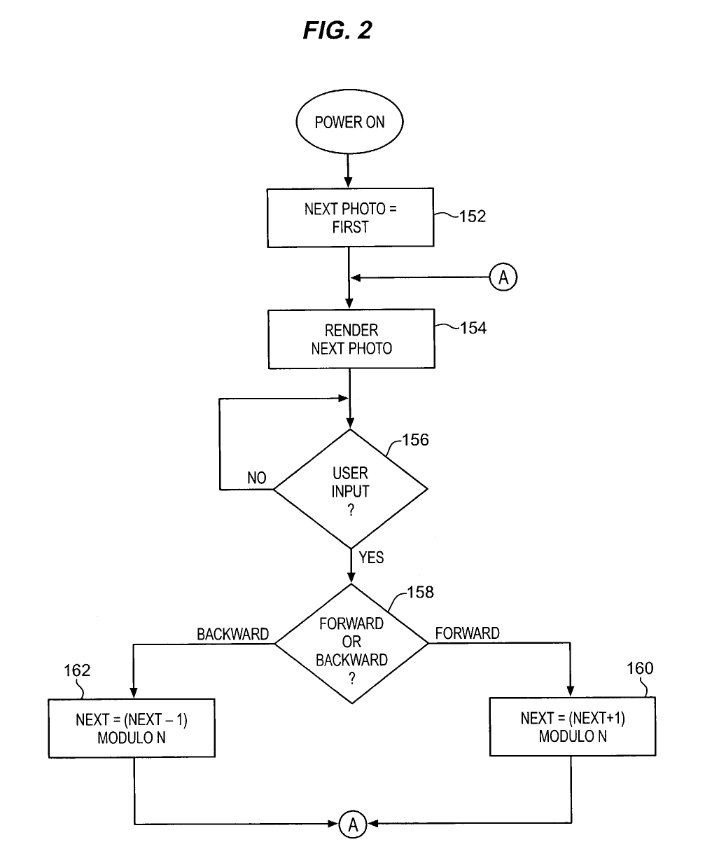

FIG. 2 illustrates one embodiment of the operational flow of the control logic provided to processor 106. As shown, upon power on, processor 106 sets a next photograph pointer to the first photograph, and display the next photograph, i.e. the first photograph, steps 152-154. Upon displaying the first photograph, processor 106 waits for additional user control input, step 156. Processor 106 repeats step 156 until a user control input is received.

When a user control input is received, processor 106 determines if the user control input is the forward control input or the backward control input, step 158. If the user control input is forward control input, processor 106 increments the next photograph pointer by one photograph, modulo N, where N is the maximum number of photograph that can be stored in portable viewer 100, and then renders the next photograph, steps 160 and 154. On the other hand, if the user control input is the backward control input, processor 106 decrements the next photograph pointer by one photograph, modulo N, and then renders the next photograph, step 162 and 154. In either case, upon rendering the next photograph, processor 100 waits for the next user control input at step 156. The operation continues until portable viewer 100 is powered off by the user depressing power control button 114.

In an alternate embodiment, portable viewer 100 may display a random one of the stored digital photographs at power on. In yet another embodiment, portable viewer 100 may be provided with additional logic to remember the last digital photograph viewed in a previous viewing session, such that at power on, the last digital photograph viewed in the immediate preceding viewing session is displayed as the first digital photograph instead. In yet other embodiments, portable viewer 100 may be provided with additional operational control features such as pan, zoom, contrast, and luminance.

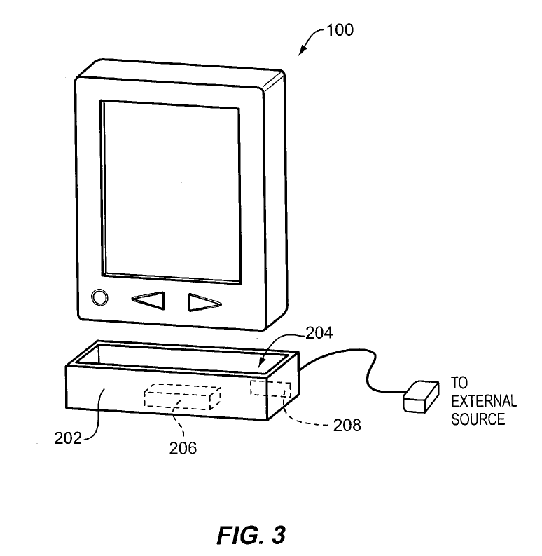

FIG. 3 illustrates one embodiment of a portable digital photograph viewer assembly. Portable digital photograph viewer assembly (portable viewer assembly) 200 includes portable viewer 100 described earlier and base unit 202. Base unit 202 includes an opening 204 that is sized in a complementary manner to accept at least in part portable viewer 100. Disposed inside the opening 202 are two Input/Output (I/O) interfaces 206-208. I/O interface 206 is used to electrically mate with communication interface 110 of portable viewer 100 described earlier. I/O interface 208 is used to couple portable viewer assembly 200 with an external source, such as a desktop computer, to receive the digital photographs. I/O interface 208 may be a parallel port, a universal serial bus port, an IEEE 1394 compatible port, or other like I/O interfaces. Universal serial bus is described in the Universal Serial Bus Specification, Revision 1.0, Jan. 16, 1996, available from Intel Corp., of Santa Clara, Calif., and IEEE 1394 is described in the High Performance Serial Bus specification, IEEE Standard 1394, draft 8.0v3, approved Dec. 12, 1995, available from IEEE.

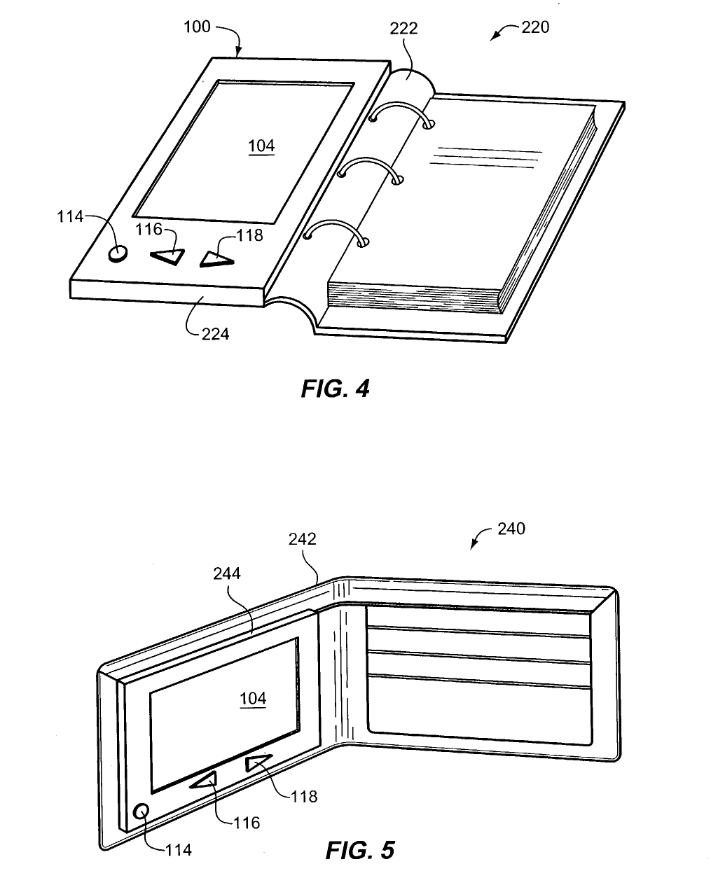

FIGS. 4-6 illustrate various exemplary embodiments of portable digital photograph viewer and personal accessory combinations, including a viewer and organizer combination, a viewer and wallet combination, and a viewer and key chain combination. These are just a few exemplary viewer and personal accessory combinations. Numerous other viewer and personal accessory combinations may be formed in accordance with the teachings of the various embodiments of the present invention.

As shown in FIG. 4, portable digital photograph viewer and organizer combination 220 includes portable viewer 100, described earlier, and a personal organizer 222. Personal organizer 222 includes a compartment 224, which is used to house the various components of portable viewer 100, such as printed circuit board 120, processor 106, and so forth. Flat panel display 104 is sized in a complementary manner such that it is disposed on an interior “top” surface of compartment 224, facilitating easy access to the control buttons 114-118 of portable viewer 100, and viewing of the rendered photographs.

Shown in FIG. 5 is one embodiment of a portable digital photograph viewer and wallet combination 240. Combination 240 includes portable viewer 100, described earlier, and a wallet 242. Wallet 242 includes compartment 244, which is used to house the various components of portable viewer 100, such as printed circuit board 120, the processor 106, and so forth. Flat panel display 104 is sized in a complementary manner such that it is disposed on an interior “top” surface of compartment 244, facilitating easy access to the control buttons 114-118 of portable viewer 100, and viewing of the rendered photographs. Other styles of wallet 242 may be employed.

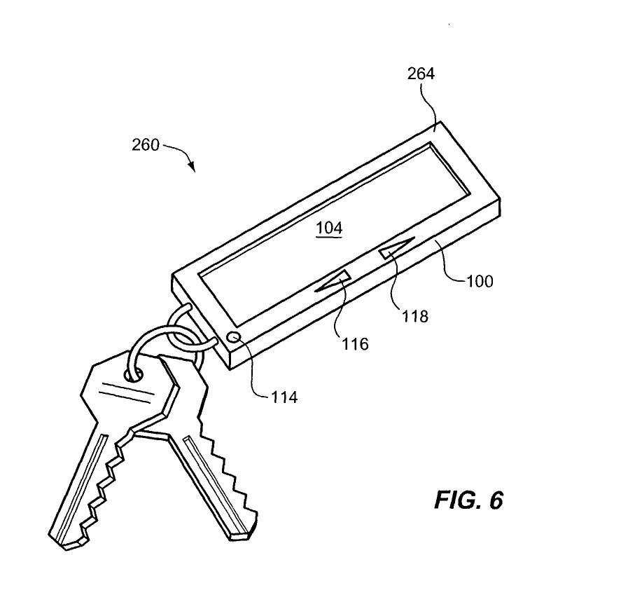

Shown in FIG. 6 is one embodiment of a portable digital photograph viewer and key chain combination 260. Combination 260 includes portable viewer 100, described earlier, and a key chain 262. Key chain 262 includes a handle 264, which is used to house the various components of portable viewer 100, such as printed circuit board 120, processor 106, and so forth. Flat panel display 104 is sized in a complementary manner such that it is disposed on one of the exterior surfaces of handle 264, facilitating easy access to the control buttons 114-118 of portable viewer 100, and viewing of the rendered photographs. In one embodiment, a handle 264 may have exterior physical dimensions of 3″×1.5″×0.25″. Other styles of key chain 262 may be employed.

In general, those skilled in the art will recognize that the present invention is not limited by the details described; instead, the present invention can be practiced with modifications and alterations within the spirit and scope of the appended claims. The description is thus to be regarded as illustrative instead of restrictive on the present invention.

Thus, a portable digital photograph viewer and integration of the portable digital photograph with various personal accessories have been described.

What is claimed is:

1. An assembly comprising:
a non-volatile memory to store a plurality of digital photographs;
a display to render the stored digital photographs;
a processor coupled with the non-volatile memory and the display, the processor to control the rendering of the stored digital photographs;
a first input/output (I/O) port coupled to the non-volatile memory to receive the plurality of digital photographs from an external source;
an enclosure to house the non-volatile memory, the display, the processor, and the first I/O port, the enclosure having physical dimensions in the order of hand held portable devices, and the display being sized in a complementary manner and disposed on a surface of the enclosure; and
a base unit having an opening sized in a complementary manner with the enclosure to at least partially accept the enclosure, the base unit further having a second I/O port and a third I/O port to electrically mate with the first I/O port and the external source, respectively, to communicate the plurality of digital photographs between the external source and the first I/O.

2. The assembly of claim 1, further comprising a plurality of control buttons disposed on the surface of the enclosure and coupled with the processor, the plurality of control buttons to communicate user inputs with the processor to control the rendering of the stored digital photographs.

3. The assembly of claim 1, wherein the non-volatile memory comprises at least one of the following: a block erasable flash memory, an electrically erasable programmable read only memory (EEPROM), and a complementary metal oxide semiconductor (CMOS) memory.

4. The assembly of claim 1, wherein the third I/O port comprises at least one of the following: a parallel port, a universal serial bus port, and an IEEE 1394 compatible port.

5. The assembly of claim 1, wherein the processor comprises at least one of the following: one of an 8-bit or more microcontroller, a 16-bit or more digital signal processor, and a 32-bit or more general-purpose microprocessor.

6. A device comprising:
an organizer having a plurality of compartments including a first compartment having physical dimensions in the order of hand held portable devices; and
a portable digital photograph viewer housed by the first compartment of the organizer, the portable digital photograph viewer having:
a non-volatile memory disposed inside the first compartment of the organizer to store a plurality of digital photographs;
a display disposed on a surface of the first compartment of the organizer, the display having physical dimensions smaller than the physical dimensions of the surface of the first compartment of the organizer, to render the stored digital photographs; and
a processor disposed inside the first compartment of the organizer and coupled with the non-volatile memory and with the display, the processor to control the rendering of the stored digital photographs on the display.

7. The device of claim 6, wherein the device further comprising a plurality of control buttons disposed on the surface of the first compartment of the organizer and coupled with the processor, the plurality of control buttons to communicate user inputs with the processor to control the rendering of the stored digital photographs.

8. The device of 6, wherein the non-volatile memory comprises at least one of the following: a block erasable flash memory, an electrically erasable programmable read only memory (EEPROM), and a complementary metal oxide semiconductor (CMOS) memory.

9. The device of claim 6, wherein the processor comprises at least one of the following: an 8-bit or more microcontroller, a 16-bit or more digital signal processor, and a 32-bit or more general-purpose microprocessor.

10. A device comprising:
a wallet having a plurality of compartments including a first compartment having physical dimensions in the order of hand held portable devices; and
a portable digital photograph viewer housed by the first compartment of the wallet, the portable digital photograph viewer having:
a non-volatile memory disposed inside the first compartment of the wallet to store a plurality of digital photographs;
a display disposed on a surface of the first compartment of the wallet, the display having physical dimensions smaller than the physical dimensions of the first compartment of the wallet, to render the stored digital photographs; and
a processor disposed inside the first compartment of the wallet and coupled with the non-volatile memory and with the display, the processor to control the rendering of the stored digital photographs on the display.

11. The device of claim 10, further comprising a plurality of control buttons disposed on the surface of the first compartment of the wallet and coupled with the processor, the plurality of control buttons to communicate user inputs with the processor to control the rendering of the stored digital photographs.

12. The device of claim 10, wherein the non-volatile memory comprises at least one of the following: a block erasable flash memory, an electrically erasable programmable read only memory (EEPROM), and a complementary metal oxide semiconductor (CMOS) memory.

13. The device of claim 10, wherein the processor comprises at least one of the following: an 8-bit or more microcontroller, a 16-bit or more digital signal processor, and a 32-bit or more general-purpose microprocessor.

14. A device comprising:
a key chain having a handle with physical dimensions in the order of hand held portable devices; and
a portable digital photograph viewer housed by the handle of the key chain, the portable digital photograph viewer having:
a non-volatile memory disposed inside the handle of the key chain that to store a plurality of digital photographs;
a display disposed on a surface of the handle of the key chain, the display having physical dimensions smaller than the physical dimensions of the handle of the key chain, to render the stored digital photographs; and
a processor disposed inside the handle of the key chain and coupled with the non-volatile memory and with the display, the processor to control the rendering of the stored digital photographs on the display.

15. The device of claim 14, further comprising a plurality of control buttons disposed on the surface of the handle of the key chain and coupled with the processor, the plurality of control buttons to communicate user inputs to the processor with control the rendering of the stored digital photographs.

16. The device of claim 14, wherein the non-volatile memory comprises at least one of the following: a block erasable flash memory, an electrically erasable programmable read only memory (EEPROM), and a complementary metal oxide semiconductor (CMOS) memory.

17. The device of claim 14, wherein the processor comprises one of the following: an 8-bit or more microcontroller, a 16-bit or more digital signal processor, and a 32-bit or more general-purpose microprocessor.

18. A device comprising:
a personal accessory having a compartment with physical dimensions in the order of hand held portable devices; and
a portable digital photograph viewer housed by the compartment of the personal accessory having:
a non-volatile memory disposed inside the compartment of the personal accessory to store a plurality of digital photographs;
a display disposed on a surface of the compartment of the personal accessory, the display having physical dimensions smaller than the physical dimensions of the compartment of the personal accessory, to render the stored digital photographs; and
a processor disposed inside the compartment of the personal accessory and coupled with the non-volatile memory and with the display, the processor to control the rendering of the stored digital photographs on the display.

19. The device of claim 18, further comprising a plurality of control buttons disposed on the surface of the compartment of the personal accessory and coupled with the processor, the plurality of control buttons to communicate user inputs with the processor to control the rendering of the stored digital photographs.

20. The device of claim 18, wherein the non-volatile memory comprises at least one of the following: a block erasable flash memory, an electrically erasable programmable read only memory (EEPROM), and a complementary metal oxide semiconductor (CMOS) memory.

21. The device of claim 18, wherein the processor comprises at least one of the following: an 8-bit or more microcontroller, a 16-bit or more digital signal processor, and a 32-bit or more general-purpose microprocessor.

22. An apparatus comprising:
means for storing a plurality of digital photographs;
means for rendering the stored digital photographs;
means for controlling the rendering of the stored digital photographs, the means for controlling coupled with the means for storing and the means for rendering;
means for receiving the plurality of digital photographs from an external source, the means for receiving coupled with the means for storing;
means for housing the means for storing, the means for rendering, the means for controlling, and the means for receiving, the means for housing having physical dimensions in the order of hand held portable devices, and the means for rendering being sized in a complementary manner and disposed on a surface of the means for housing; and
means for accepting the means for housing, the means for accepting having an opening sized in a complementary manner with the means for housing for at least partially accepting the means for housing, the means for accepting further having means for electrically mating with the means for receiving and the external source for communicating the plurality of digital photographs between the external source and the means for receiving.

23. The apparatus of claim 22, further comprising means for communicating user inputs with the means for controlling the rendering of the stored digital photographs, the means for communicating disposed on the surface of the means for housing and coupled with the means for controlling.

24. The apparatus of claim 22, wherein the means for storing comprising at least one of the following: a block erasable flash memory, an electrically erasable programmable read only memory (EEPROM), and a complementary metal oxide semiconductor (CMOS) memory.

25. The apparatus of claim 22, wherein the means for controlling comprising at least one of the following: an 8-bit or more microcontroller, a 16-bit or more digital signal processor, and a 32-bit or more general-purpose microprocessor.

26. An apparatus comprising:
means for housing having a compartment with physical dimensions in the order of hand held portable devices; and
means for receiving housed by the compartment of the means for housing having:
means for storing a plurality of digital photographs, the means for storing disposed inside the compartment of the means for housing;
means for rendering the stored digital photographs, the means for rendering disposed on a surface of the compartment of the means for housing, the means for rendering having physical dimensions smaller than the physical dimensions of the compartment of the means for housing; and
means for controlling the rendering of the stored digital photographs, the means for controlling disposed inside the compartment of the means for housing and coupled with the means for storing and with the means for rendering the stored digital photographs.

27. The apparatus of claim 26, further comprising means for communicating user inputs with the means for controlling the rendering of the stored digital photographs, the means for communicating disposed on the surface of the compartment of the means for housing and coupled with the means for controlling.

28. The apparatus of claim 26, wherein the means for storing comprising at least one of the following: a block erasable flash memory, an electrically erasable programmable read only memory (EEPROM), and a complementary metal oxide semiconductor (CMOS) memory.

29. The apparatus of claim 26, wherein the means for controlling comprising at least one of the following: an 8-bit or more microcontroller, a 16-bit or more digital signal processor, and a 32-bit or more general-purpose microprocessor.

30. A method comprising:
receiving a plurality of digital photographs from an external source using a first input/output (I/O) port coupled with a non-volatile memory;
housing the non-volatile memory, a display, a processor, and the first I/O port using an enclosure, wherein the enclosure comprising physical dimensions in the order of hand held portable devices, and the display being sized in a complementary manner and disposed on a surface of the enclosure; and
at least partially accepting the enclosure using a base unit having an opening sized in a complementary manner with the enclosure, wherein the base unit comprising a second I/O port and a third I/O port to electrically mate with the first I/O port and the external source, respectively, to communicate the plurality of digital photographs between the external source and the first I/O.

31. The method of claim 30, further comprising:
storing the plurality of digital photographs using the non-volatile memory;
rendering the stored digital photographs using the display; and
controlling the rendering of the stored digital photographs using the processor, wherein the processor is coupled with the non-volatile memory and the display.

32. The method of claim 30, further comprising communicating user inputs with the processor via a plurality of control buttons, wherein the plurality of control buttons is disposed on a surface of the enclosure and coupled with the processor.

33. A method comprising the steps of:
a step for receiving a plurality of digital photographs from an external source using a first input/output (I/O) port coupled with a non-volatile memory;
a step for housing the non-volatile memory, a display, a processor, and the first I/O port using an enclosure, wherein the enclosure comprising physical dimensions in the order of hand held portable devices, and the display being sized in a complementary manner and disposed on a surface of the enclosure; and
a step for at least partially accepting the enclosure using a base unit having an opening sized in a complementary manner with the enclosure, wherein the base unit comprising a second I/O port and a third I/O port for electrically mating with the first I/O port and the external source, respectively, for communicating the plurality of digital photographs between the external source and the first I/O.

34. The method of claim 33, further comprising the steps of:
a step for storing the plurality of digital photographs using the non-volatile memory;
a step for rendering the stored digital photographs using the display; and
a step for controlling the rendering of the stored digital photographs using the processor, wherein the processor is coupled with the non-volatile memory and the display.

35. The method of claim 33, further comprising the step for communicating user inputs with the processor via a plurality of control buttons, wherein the plurality of control buttons is disposed on a surface of the enclosure and coupled with the processor.
